(19) United States
(12) Patent Application Publication
(10) Pub. No.: US 2002/0174310 A1
(43) Pub. Date: Nov. 21, 2002

(54) Non-volatile memory

(75) Inventor: Takayuki Ueyama, Kawasaki (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: Fujitsu Limited

(21) Appl. No.: 10/194,317

(22) Filed: Jul. 15, 2002

Related U.S. Application Data
(63) Continuation of application No. PCT/JP00/00877, filed on Feb. 16, 2000.

(51) Int. Cl. G06F 12/00

(52) U.S. Cl. 711/163; 711/103; 711/156

(57) ABSTRACT

The present invention is characterized in that, in a non-volatile memory, in response to a write command, it is judged whether or not original data of a write address contains write state data (0, for example), and, in a case where write state data is contained, a write operation of a write command is prohibited. Or the present invention is characterized in that, in a non-volatile memory, in response to a write command, original data of a write address and write data corresponding to the write command are compared, and in a case where bits changing write state data to erased state data are contained, a write operation for this write command is prohibited.

### TECHNICAL FIELD

The present invention relates to a semiconductor non-volatile memory, and more particularly to a non-volatile memory which is capable of prohibiting a write operation upon detecting writing of non-writable data in advance, and is capable of protecting existing data.

### BACKGROUND ART

Semiconductor non-volatile memories comprising memory cells which have a floating gate have come into widespread use as flash memories or non-volatile memories. Non-volatile memories have a type of microprocessor called a sequencer housed therein, and the sequencer controls the internal operations of the memory in response to commands from outside such as write command (programming command), erase command, read command, and reset command, and the like.

FIG. 1 illustrates a write operation and an erase operation of the non-volatile memory. A write (programming) operation is shown on the left side of the figure, and an erase operation on the right side thereof. The control gate of the memory cell transistor MC is connected to a word line WL, the drain thereof is connected to a bit line BL, and the source thereof is connected to a source line SL.

In a write operation, a high positive voltage of 9V, for example, is applied to the word line WL, a positive voltage of 5V is also applied to the bit line BL, and the source line SL is grounded. As a result, electrons are injected from the drain to the floating gate. In an erase operation, the bit line BL is open, and a negative voltage of −9V, for example, is applied to the word line WL, and a positive voltage to the source line SL, such that electrons stored within the floating gate are extracted therefrom.

Therefore, writing (programming) is an operation in which electrons are injected into the floating gate to change data from a “1” of an erased state to a “0” of a programmed state, and erasing is an operation in which electrons are extracted from the floating gate to render a change from a “0” of a programmed state to a “1” of an erased state. In the present invention, the term “write operation” is used in the same sense as a programming operation which changes the threshold of a memory cell transistor from a low state to a high state.

Generally, in non-volatile memories such as flash memories, writing (programming) is possible in one bit units, whereas erasing is typically performed in sector units containing a plurality of memory cells. Consequently, writing a certain data in a memory is performed by writing or not writing data 0 to memory cells in an erased state. In other words, a plurality of write data constituting write units is typically written to a region of memory cells all of which are erased state.

FIG. 2 is a flowchart for a write operation corresponding to a write command of the prior art. When a write command, and corresponding write address, and write data are inputted to the non-volatile memory (S1), same responds to this write command, and a sequencer constituting a control circuit applies a write stress to the memory cell designated by the write address (S5). Write stress is applied by applying the write pulse shown in FIG. 1 over a predetermined time interval. Also, a verify check is performed of whether or not a match exists between data read out from a memory cell designated by a write destination address, and write data (S2). If this verify check yields a pass, writing is completed, but in the event of a fail, a write stress application step S5 is repeated until a specified value for the write times has been reached (S2, S3, S4, S5). In a case where a verify check has not yielded a pass even when the specified value for the write times has been reached, a write error is produced (S6). Then the memory issues a write error flag externally (S7). Such a write error typically signifies that a state has been assumed in which writing is not possible as a result of deterioration of the memory cell characteristics.

Nevertheless, as described above, performing a write command only changes a memory cell from a data 1 erased state to a data 0 programmed state. Consequently, it is not possible to store data 1 by means of a write command in an already written data 0 memory cell. This is because, in order to change data 0 to data 1, sector erase processing is then necessary.

FIG. 3 shows an example of a conventional case of write error flag generation. Normal writing is typically performed in units of 8 bits or more, for example. The example of FIG. 3 is for a case in which a memory to which original data “10101010” has already been written is newly overwritten with write data “01011010”. In this case, by means of a write command, it is possible to overwrite the first and third bits from the left from data 1 to data 0 by means of a write operation, whereas necessitating a change of the already written state of the second and fourth bits to an erased state results in a write error.

According to the write flowchart in FIG. 2 described above, writing of the first and third bits is completed normally, but in the case of the second and fourth bits, since write data is 1, there is no change to the state of the memory cell. Therefore, after the write step S5 has been repeated a number of times corresponding to a specified value, the verify check cannot be passed, and instead a write error results and a write error flag is issued.

As described earlier, the fact that it is not possible to pass a verify check even after writing has been performed a specified number of times and that a write error flag is then issued serves to indicate that writing cannot be performed normally due to deterioration of the memory cell characteristics. However, in the example above, an error flag is generated when a change from data 0 to data 1 is attempted using a write command.

A write error flag such as that mentioned above is generated after a write operation has been executed a specified number of times. Therefore, firstly, it takes time to execute a write operation a specified number of times until it is recognized that a non-executable data change has been attempted. Secondly, since data can be written to another writable bit, the possibility exists of original data being changed irrespective of a write error.

Therefore, an object of the present invention is to provide a non-volatile memory which is capable of preventing the generation of a write error which arises when a non-executable data change is attempted.

It is another object of the present invention to provide a non-volatile semiconductor memory which is capable of protecting original data even when a non-executable data change is attempted.

### DISCLOSURE OF THE INVENTION

In order to achieve the above-mentioned objects, a first aspect of the present invention is characterized in that, in a non-volatile memory, in response to a write command, it is judged whether or not original data of a write address contains write state data (0, for example), and, in a case where write state data is contained, a write operation of a write command is prohibited.

In order to achieve the above-mentioned objects, a second aspect of the present invention is characterized in that, in a non-volatile memory, in response to a write command, original data of a write address and write data corresponding to the write command are compared, and in a case where bits changing write state data to erased state data are contained, a write operation for this write command is prohibited.

According to the above-mentioned invention, in a case where new data is overwritten to an already written memory cell by means of a write command, a check is performed of whether a write error will be generated, prior to the execution of a write operation, or whether there is a possibility of a write error being generated. Consequently, the generation of a write error, as a result of a match between write data and original data following the execution of a write operation, can be detected in advance.

Furthermore, a third aspect of the present invention is characterized in that, in a non-volatile memory, in a case where a memory cell to be written is in a programmed state, or in a case where a memory cell to be written is in a programmed state and write data is of an erase state, a verify check at the time of writing is not performed with respect to the above-mentioned memory cell.

In a more preferable embodiment, exemption from the above a verify check is performed in response to a predetermined operation command. As a result, in a case where an attempt is made to overwrite data of memory cells that include a cell of a write state for any reason, it is possible to prevent the production of a write error as a result of non-mathcing write data and memory cell data, and to validate a compulsory overwrite.

### BRIEF DESCRIPTION OF THE DRAWINGS

FIG. 1 illustrates a write operation and an erase operation of a non-volatile memory;

FIG. 2 is a flowchart for a write operation corresponding to a write command of the prior art;

FIG. 3 shows an example of a conventional case of write error flag generation;

FIG. 4 shows the whole constitution of the non-volatile memory of the present embodiment;

FIG. 5 is an operation flowchart with respect to a write command of a first embodiment;

FIG. 6 shows an example of write data to illustrate the first embodiment;

FIG. 7 is an operation flowchart with respect to a write command of a second embodiment;

FIG. 8 shows an example of write data to illustrate the second embodiment;

FIG. 9 is an operation flowchart with respect to a write command of a third embodiment; and

FIG. 10 is an operation flowchart with respect to a write command of the third embodiment.

### BEST MODE FOR CARRYING OUT THE INVENTION

A preferred embodiment of the present invention will be described hereinbelow with reference to the drawings.

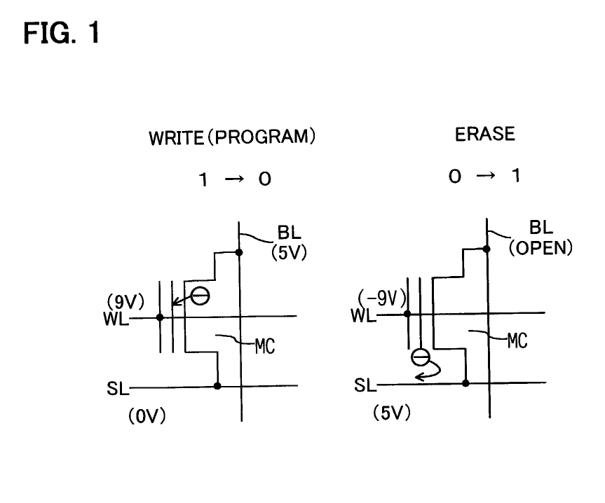

FIG. 4 shows the whole constitution of the non-volatile memory of the present embodiment. The memory in FIG. 4 has a memory cell matrix 10 having a plurality of memory cells shown in FIG. 1; a decoder 12 of the memory cell matrix 10; a command register 14, which is supplied with commands CMD from outside and decodes same to generate internal signals; and a control circuit 16, which responds to internal control signals from the command register 14 to perform control of internal operations corresponding to commands. This control circuit 16 is constituted by a microprocessor, for example, and controls a programming voltage generation circuit 18 and a verify circuit 22, and the like, in response to control signals from the command register 14.

Moreover, the memory in FIG. 4 has a data input circuit 20, which holds write data supplied from outside, and supplies this write data to the cell matrix 10. Further, the most important characteristic of the constitution lies with the provision of a judgement unit 24 for judging data stored in the cell matrix. In the First Example, this judgement unit 24 judges whether or not a programmed state data 0 is contained in data of a memory cell to which writing is to be performed. Then, if such data is contained, the judgement unit 24 externally issues a write impossibility flag WEF, and supplies a judgement result signal S24 to the control circuit 16 which is a sequencer. Further, in a Second Example, the judgement unit 24 compares original data and write data to judge whether or not a bit requiring a change from a programmed state data 0 to an erased state data 1 is present. When such a bit exists, the judgement unit 24 issues a write impossibility flag WEF, and supplies a judgement result signal S24 to the control circuit 16. The judgement unit 24 may be mounted in the control circuit 16.

When a command to cancel a write prohibition is inputted to the control circuit 16, same cancels the write prohibition, and performs a write operation even for data for which writing is impossible. Alternatively, in a case where a command to cancel a write capability judgement is supplied thereto, the control circuit 16 supplies a write capability judgement cancellation signal S16 to the judgement unit 24, and the control circuit performs a write operation without a judgement being performed by means of the judgement unit 24. Further, also in a case where any given command is supplied, at the time of a write operation, the control circuit 16 supplies a verify avoidance signal S17, which cancels a verify operation for bits whose original data is programmed state, or which is changed from a programmed state to an erased state by a write operation, to the verify circuit 22. As a result, a hung-up due to a verify operation can be avoided when writing is performed compulsorily.

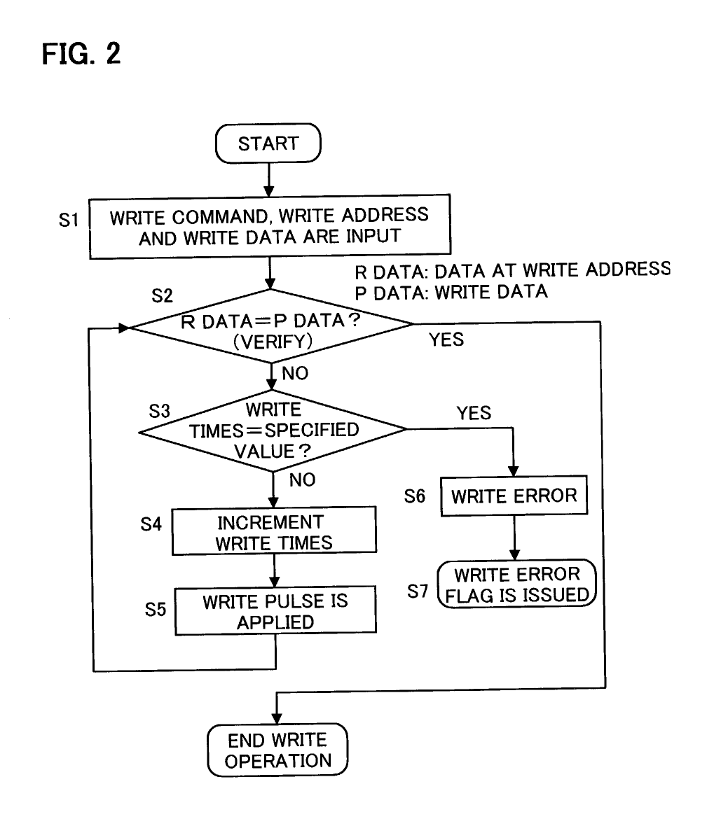

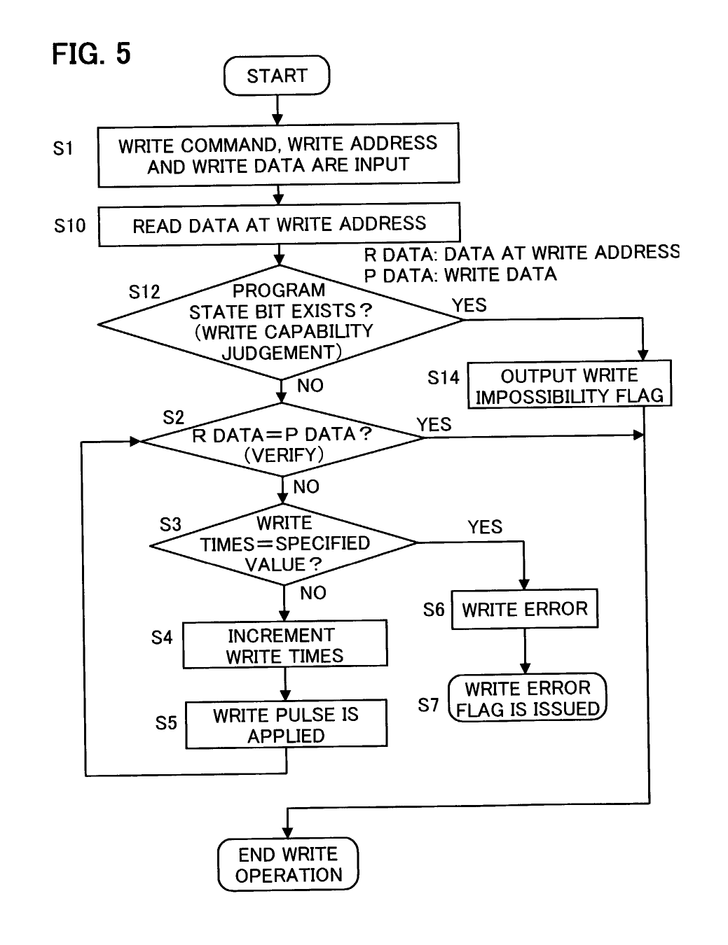

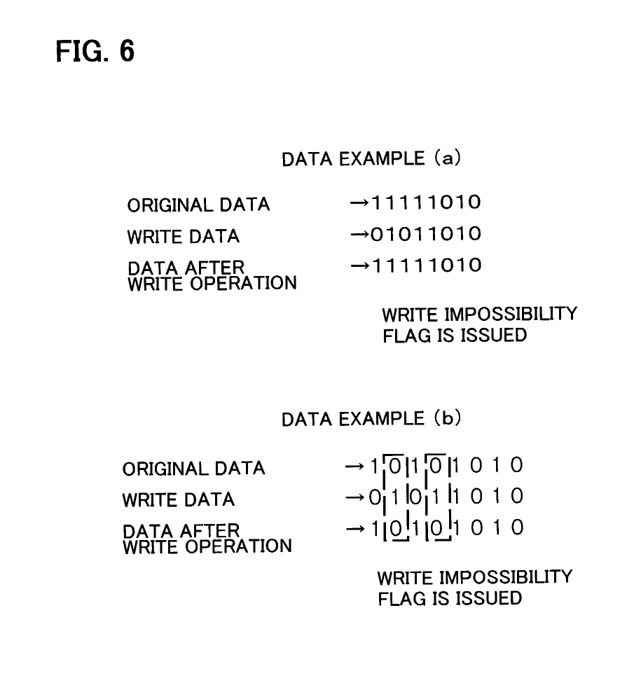

FIG. 5 is an operation flowchart for a write command of a first embodiment. In FIG. 5, steps which are the same as those in the flowchart of FIG. 2 illustrated as a conventional example have been assigned the same numbers. Therefore, in the flowchart of FIG. 5, the steps S10, S12, S14 are newly added steps. FIG. 6 shows an example of write data to illustrate the First Example.

In the first embodiment, in accordance with a control signal from the control circuit 16 in response to a write command, the judgement unit 24 reads out stored data of a memory cell designated by a write address, and performs a judgement of whether a programmed state data 0 is contained in original data. Then, in a case where data 0 is contained in the original data, the judgement unit 24 externally issues a write impossibility flag WEF, and supplies the judgement result to prohibit the write operation to the control circuit 16. In response thereto, the control circuit 16 does not perform a write operation corresponding to the write command. Specifically, the control circuit 16 disables the programming voltage generation circuit 18 and subsequently prohibits the write operation.

As shown in FIG. 5, a write command, a write address corresponding thereto, and write data, are supplied to the memory device. Before performing the serial write operations S2 to S7 which include the application of write stress corresponding to this write command, the control circuit 16 causes the judgement unit 24 to read out data in eight-bit write units from a memory cell designated by a write address (S10), and to perform a write capability judgement of whether programmed data 0 is contained in this original data (S12). Then, if data 0 is contained therein, the judgement unit 24 issues and externally outputs a write impossibility flag WEF (S14).

When it is detected using the judgement unit 24 that data 0 is not contained, since it is possible to perform a write operation to a memory cell of the corresponding address regardless of the write data, the serial write operations S2 to S7 are executed. The write operations are the same as those of the conventional example. Consequently, a write error flag is issued if there is no match between memory cell data and write data even upon applying write stress a specified number of times, and writing to this sector is subsequently prohibited. Such a write error flag is mainly caused by deterioration of the memory cell characteristics.

To illustrate this using the specific data example in FIG. 6, in data example (a), original data stored at a write address is “11111010”, and write data which is to overwrite same is “01011010”. Here, overwriting is possible with regard to writing the first and third bits from an erased state data 1 to a programmed state data 0. However, in the first embodiment, since a write state data 0 is contained in the original data, a write impossibility flag WEF is issued and the subsequent write operation is prohibited. Consequently, data following the write command execution is unchanged original data “11111010”. Therefore, with the original data still protected, a write impossibility flag WEF is issued.

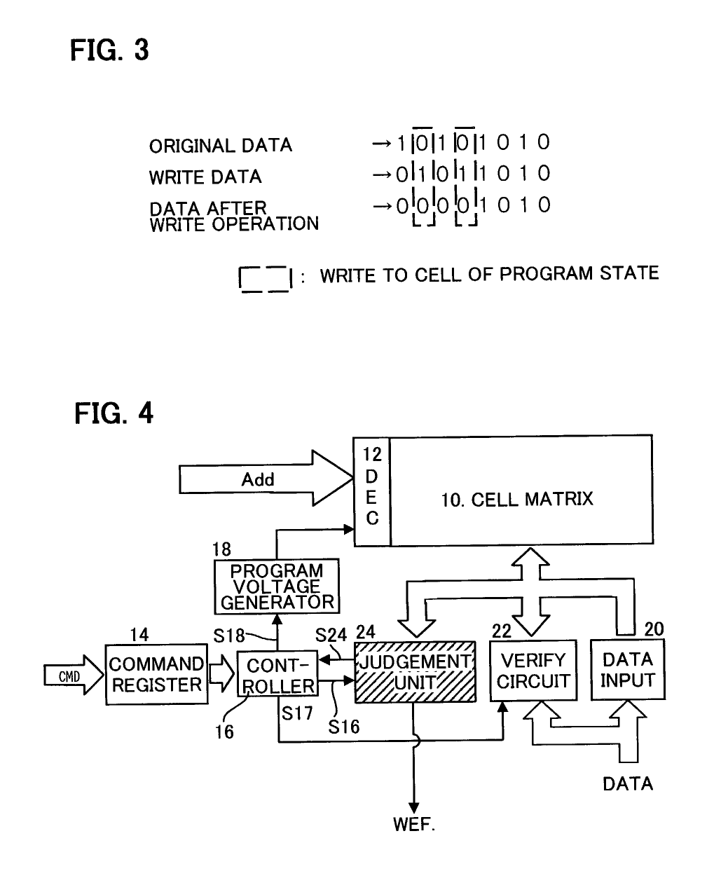

In data (b), original data stored at a write address is “10101010”, and write data with which same is to be overwritten is “01011010”. Here, like the conventional example in FIG. 3, there is a requirement to change the second and fourth bits from programmed state data 0 to erased state data 1. Consequently, overwriting is impossible in the execution of a write command. In the first embodiment, it is detected using the judgement unit 24 that programmed state data 0 is contained in original data, and a write impossibility flag WEF is issued, and the subsequent write operation is prohibited. Therefore, this can avoid the issuance of programming error flag and the programming error where the original data has been changed which are caused by the 2^{nd} bit and the 4^{th} bit not being overwritten. The application of the write voltage is not performed for each bit but rather simultaneously with respect to a plurality of bits. Moreover, the verify operation is not performed for each application of a one-bit write voltage but instead in write units such as byte units.

When the judgement unit 24 issues a write impossibility flag WEF, the memory controller connected with the memory issues a write command to a separate address, for example. Alternatively, the memory controller issues a reset command, clears the write impossibility flag, and saves data of a sector targeted for writing to another sector, erases the sector targeted for writing, and once more writes, to that sector, the data saved to the other sector and data which is to be written. This control is performed by means of corresponding commands from the memory controller.

In the first embodiment, when a command to cancel a write prohibition is inputted, the control unit 16 enables the write voltage generation circuit, and supplies a verify avoidance signal S17 to the verify circuit 22. Upon receiving this signal, the verify circuit excludes bits corresponding to programmed state cells from being the targets of a verify check in a write operation. Thus, a verify check in a write operation can be compulsorily passed and writing can be completed without the generation of a write error in a case where impossible data overwriting is attempted.

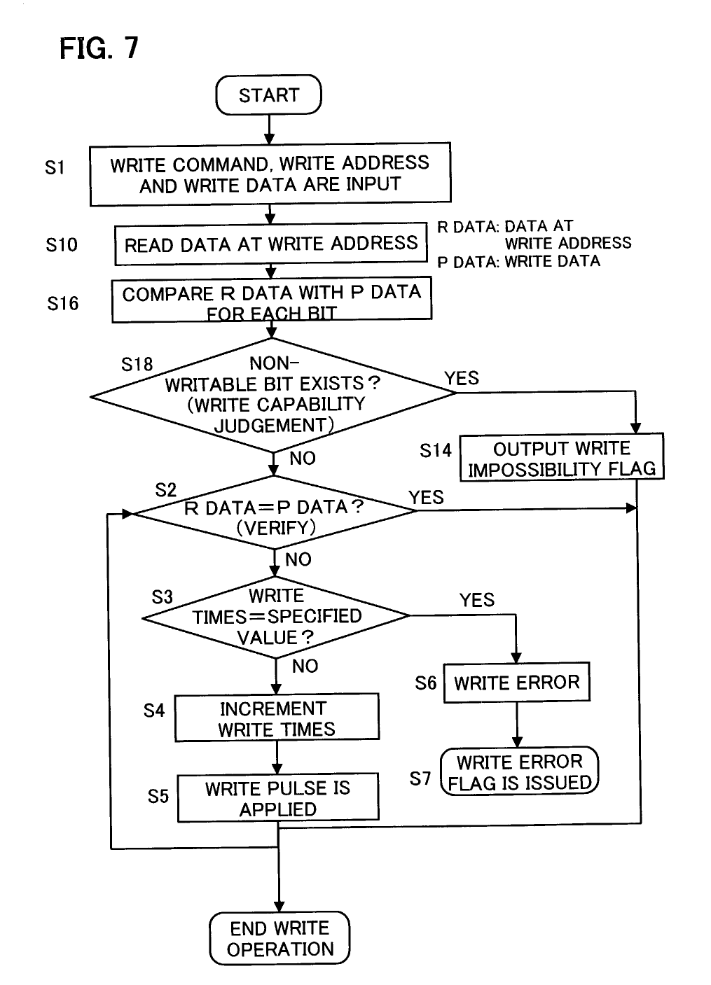

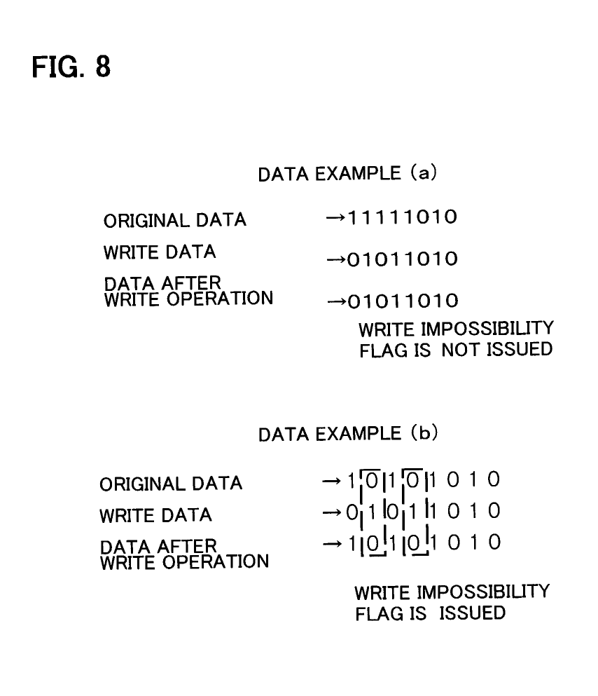

FIG. 7 is an operation flowchart for a write command of a second embodiment. In FIG. 7, steps which are the same as those in the flowchart of FIG. 2 illustrated as a conventional example have been assigned the same numbers. Therefore, in the flowchart of FIG. 7, the steps S10, S16, S18, S14 are newly added steps. FIG. 8 shows an example of write data to illustrate the second embodiment.

Initially, a write command, a write address corresponding thereto, and write data, are received from an external memory controller (S1). In response to this write command, the control circuit 16 instructs the judgement unit 24 to perform a judgement of whether or not a non-writable bit is present. The judgement unit 24 reads out data of a memory cell designated by a write address in eight-bit write units (S10), and compares read out original data and write data (S16). Then, the judgement unit 24 performs a judgement of whether original data of programmed state data 0 is to be overwritten with erase state data 1 write data (S18).

In a case where the judgement result is that a non-writable bit is present, the judgement unit 24 outputs a write impossibility flag WEF and supplies a judgement result signal S24 to the control unit 16. Further, in a case where the judgement result is that a non-writable bit is not present, since it is possible to overwrite write data in a memory cell designated by this address, serial write operations of steps S2 to S7 are executed.

In the case of data example (a) shown in FIG. 8, similarly to FIG. 6, original data is “11111010”, and write data which is to overwrite same is “01011010”. Here, the judgement unit 24 compares both data, judges that a bit for a rewrite from data 0 to data 1 is not present, and does not issue a write impossibility flag WEF. Then, the write operation for write data “01011010” is executed.

In the second embodiment, for data example (a), overwriting is executed rather than a write impossibility flag being issued. This constitutes a point of difference from the first embodiment.

In the case of data example(b), original data is “10101010”, and write data is “01011010”. Here, the judgement unit 24 detects that the second and fourth bits are non-writable, issues a write impossibility flag WEF and supplies a judgement result signal S24 to the control unit 16. In response thereto, the control unit 16 prohibits the subsequent write operation. As a result, this can avoid the issuance of programming error flag and the programming error where the original data has been changed which are caused by the 2^{nd} bit and the 4^{th} bit not being overwritten.

In response to the write impossibility flag WEF, similarly to the first embodiment, the memory controller performs overwriting of write data by issuing a reset command, issuing a sector data save command, issuing a write sector erase command, and, ultimately, issuing a write command to write saved data and write data to this write sector.

Also in the second embodiment, when a command to cancel a write prohibition is inputted to the control unit 16, same enables the write voltage generation circuit and supplies a verify avoidance signal S17 to the verify circuit 22. Upon receiving this signal, the verify circuit excludes non-writable cells from being the targets of a verify check in a write operation. Thus, a verify check in a write operation can be compulsorily passed and writing can be completed without the generation of a write error even in a case where impossible data overwriting is attempted.

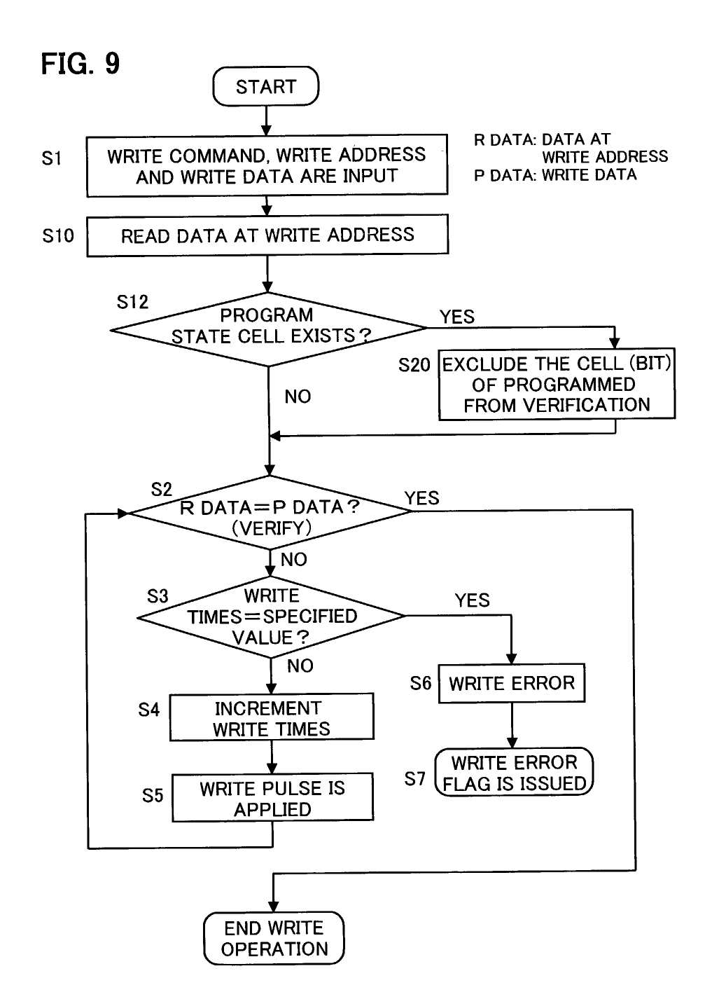

FIG. 9 is an operation flowchart with respect to a write command of a third embodiment. The same numbers are assigned to steps which are the same as in FIG. 5. The third embodiment is an example with a memory write capability judgement cancellation command. When a write capability judgement cancellation command is issued, the issuing of a write capability flag in response to a write command is prohibited, and an overwrite is executed compulsorily. The flowchart of FIG. 9 is based on the premise that this write capability judgement cancellation command has been issued.

To illustrate this with reference to the flowchart of FIG. 9, the judgement unit 24 reads out, in write units, the data of a memory cell designated by a write destination address, and performs a judgement of whether or not a programmed data 0 is present in this data (S12). Then, when a programmed cell exists, this cell is excluded from being the target of a verify check in a subsequent write operation (S20).

Then, the write operation of steps S2 to S7 is executed compulsorily. However, in the third embodiment, since a verify check at the time of a write operation with respect to programmed bits which are probably non-writable is avoided, a write error is not generated.

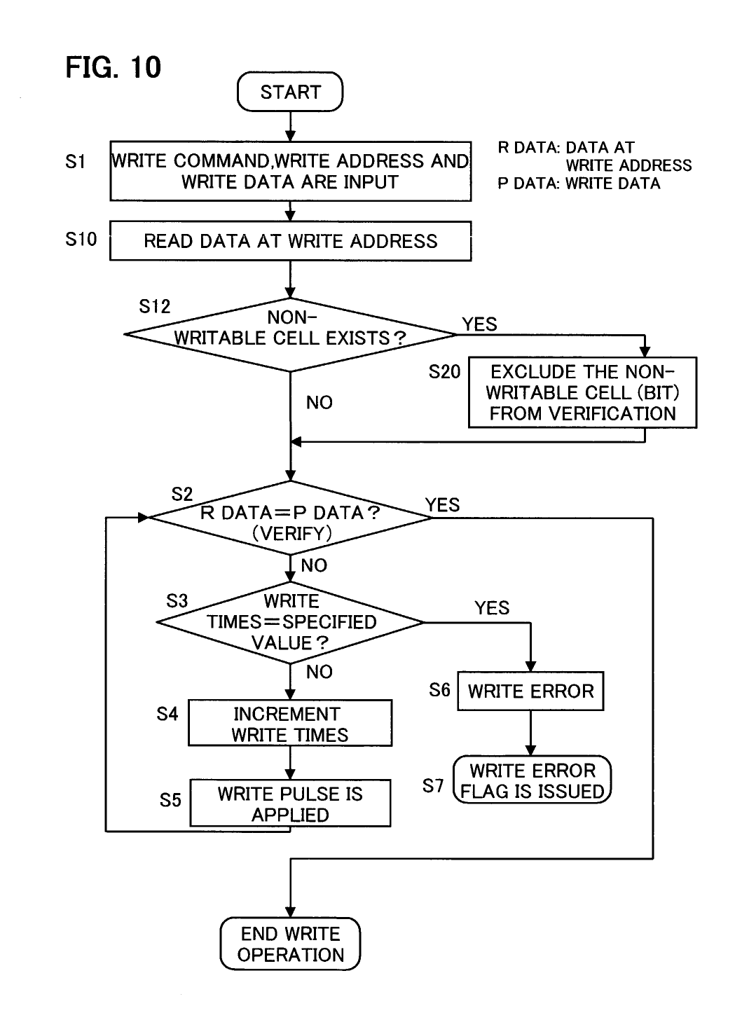

FIG. 10 is another flowchart for the third embodiment. This example is one in which a third embodiment write capability judgement cancellation command is issued in the second embodiment. The same numbers have been assigned to steps which are the same as in FIG. 7.

This flowchart is also an example in which a write capability judgement cancellation command is issued beforehand. Here, the judgement unit 24 reads out data of a write destination address all together in write units, and performs a judgement of whether or not a non-writable cell is present by means of a comparison with write data (S16, S18). Then, when a non-writable cell is present, this cell is excluded from being the target of a verify check at the time of a write operation (S20).

Then, write data is overwritten compulsorily in accordance with a write command. In this case, since a verify check for non-writable cells is avoided in the verify step, the verify operation can be passed, such that a write error is not generated. Obviously, when programming is not possible due to deterioration of memory cell characteristics, a write error flag is issued.

In the above-mentioned first embodiment and second embodiment, when a write impossibility flag is issued, the external memory controller can also change the write address and issue a command to write to another address.

### INDUSTRIAL APPLICABILITY

As described hereinabove, according to the present invention, in response to a write command, in a case where a data 0 of a programmed state is contained in data of a memory cell designated by a write address, or in a case where a non-writable bit is present, since a write impossibility flag is issued and subsequent writing is prohibited, it is possible to prevent the generation of a write error resulting from a non-executable data change being attempted, following the execution of a write operation a specified number of times. Moreover, original data can be protected even when a non-executable data change is attempted.

1. A non-volatile memory having a plurality of memory cells; and a control circuit which, in response to a write command, judges whether or not original data of a write address contains write state data, and, in a case where write state data is contained, prohibits a write operation of the write command.

2. The non-volatile memory according to claim 1, wherein said plurality of memory cells are divided into sector units, and write state data in these sector units is changed to an erased state.

3. The non-volatile memory according to claim 1, wherein, in a case where a write operation has been prohibited because said write state data is contained, a write impossibility flag indicating a write impossibility is externally outputted.

4. The non-volatile memory according to claim 3, wherein, in response to a command to cancel a write prohibition, a write prohibition is canceled and a write operation corresponding to said write command is executed.

5. The non-volatile memory according to claim 1, wherein, in response to a command to cancel a write capability judgement, said judgement is not performed and a write operation corresponding to said write command is executed.

6. The non-volatile memory according to claims 4 or 5, wherein, in said write operation, a write stress is applied to said write address memory cell, and in a case where a verify step which identifies that data of the memory cell matches write data is not passed even if said write stress is applied a specified number of times, a write error flag is issued; and
said control circuit performs control with respect to a write operation executed in response to a command to cancel said write capability judgement or a command to cancel a write prohibition such that, in a case where write state data is contained in original data of a write address, said verify step with respect to this original data is omitted or compulsorily passed.

7. A non-volatile memory having a plurality of memory cells; and a control circuit which, in response to a write command, compares original data of a write address and write data corresponding to said write command, and, in a case where a first bit that changes write state data to erased state data is contained in said write data, prohibits a write operation of this write command.

8. The non-volatile memory according to claim 7, wherein said plurality of memory cells are divided into sector units, and write state data in these sector units is changed to an erased state.

9. The non-volatile memory according to claim 7, wherein, in a case where a write operation has been prohibited because said first bit is contained, a write impossibility flag indicating a write impossibility is externally outputted.

10. The non-volatile memory according to claim 9, wherein, in response to a command to cancel a write prohibition, a write prohibition is canceled and a write operation corresponding to said write command is executed.

11. The non-volatile memory according to claim 7, wherein, in response to a command to cancel a write capability judgement, said judgement is not performed and a write operation corresponding to said write command is executed.

12. The non-volatile memory according to claims 10 or 11, wherein, in said write operation, a write stress is applied to said write address memory cell, and in a case where a verify step which identifies that data of the memory cell matches write data is not passed even if said write stress is applied a specified number of times, a write error flag is issued; and
said control circuit performs control with respect to a write operation executed in response to a command to cancel said write capability judgement or a command to cancel a write prohibition, such that, in a case where said first bit is contained in said write data, said verify step with respect to the original data is omitted or compulsorily passed.
